(19) United States
(12) Patent Application Publication
(10) Pub. No.: US 2017/0243239 A1
(43) Pub. Date: Aug. 24, 2017

(54) Incentivized navigation

(71) Applicants: Dany El-Eid, Dubai (AE); Hazem Rushdi Mohamed, Dubai (AE)

(72) Inventors: Dany El-Eid, Dubai (AE); Hazem Rushdi Mohamed, Dubai (AE)

(21) Appl. No.: 15/441,397

(22) Filed: Feb. 24, 2017

Related U.S. Application Data
(60) Provisional application No. 62/299,487, filed on Feb. 24, 2016.

(51) Int. Cl. G06Q 30/02; G08B 7/06; G01C 21/20

(52) U.S. Cl. CPC G06Q 30/0208; G01C 21/20; G08B 7/066

(57) ABSTRACT

Methods and systems for directing users to a location. Embodiments include a user interface for receiving data regarding a task to be performed by a user and data regarding one or more rewards associated with the task. A user may then perform the task at a physical location, a virtual location, or some combination thereof to receive the reward.

### CROSS REFERENCE TO RELATED APPLICATIONS

The present application claims priority to U.S. provisional application No. 62/299,487 filed on Feb. 24, 2016, the entire disclosure of which is hereby incorporated by reference as if set forth in its entirety herein.

### TECHNICAL FIELD

This invention generally relates to methods and systems for directing users to a location and, more particularly but not exclusively, to methods and systems for directing users to a location using computer-generated graphics.

### BACKGROUND

Brick-and-mortar retailers are becoming less popular as a place to purchase goods as online shopping and purchasing has become more widespread. If anything, brick-and-mortar retailers have effectively become a communication channel in which a consumer may visit a store to view or experience a product, only to later purchase it online. With this trend, these offline retailers have become less competitive with online retail channels.

Accordingly, there is a need for methods and systems that brick-and-mortar stores and other physical locations can use to incentivize consumers to visit their locations and to encourage consumers to make purchases at their locations.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a method of directing users to at least one location. The method includes receiving, via a user interface, data specifying at least one task to be performed by a user at a location; receiving, via the user interface, data specifying at least one reward associated with the task; receiving, via the user interface, at least one criterion selected from the group consisting of age, gender, user subscriptions, and user preferences; retrieving, via a processor from at least one database, a user that satisfies the at least one criterion; publishing, via the processor, data regarding the at least one task to the user; receiving, via the processor, confirmation that the user performed the task at the location; and issuing, via the processor, the at least one reward to the user after receiving the confirmation.

In one embodiment, the at least one reward includes one or more of a discount coupon, a gift voucher, monetary credit, digital currency, and cryptocurrency.

In one embodiment; the reward is issued to the user through a blockchain-based system.

In one embodiment; the method further includes receiving, via the user interface, data specifying a time period for the performance of the at least one task by the user, and the confirmation indicates that the task was performed within the time period.

In one embodiment, the task is published to one or more users via one or more electronic devices that are configured to change their displays as the user changes the electronic device's orientation. In on embodiment, the user performs the task by performing one or more of pushing a button on the electronic device, pushing buttons on the electronic device in a sequence, performing touchscreen gestures on the electronic device, and rotating the electronic device. In one embodiment, the method further includes prompting, using the electronic device, the user to perform the at least one task. In one embodiment, the user is prompted to perform the at least one task upon entering a defined location. In one embodiment, publishing data specifying the at least one task includes publishing data via at least one of auditory, visual, and haptic-based means on the electronic device. In one embodiment, the user is prompted to perform the at least one task upon scanning an indicia using the electronic device.

According to another aspect, embodiments relate to a system for directing users to at least one location. The system includes a user interface configured to receive data specifying at least one task to be performed by a user at a location, receive data specifying at least one reward associated with the task, and receive at least one criterion selected from the group consisting of user age, user sex, user subscriptions, and user preferences; a memory; and a processor, the memory storing instructions configuring the processor to retrieve, from at least one database, a user that satisfies the at least one criterion; publish data regarding the at least one incentive task to the user; receive confirmation that the user performed the task at the location; and issue the at least one reward to the user after receiving the confirmation.

In one embodiment, the at least one reward includes one or more of a discount coupon, a gift voucher, monetary credit, digital currency, and cryptocurrency.

In on embodiment, the user interface is further configured to receive data specifying a time period for the performance of the at least one task by the user, and the confirmation indicates that the task was performed within the time period.

In one embodiment, the task is published to one or more users via one or more electronic devices that are configured to change their displays as the user changes the electronic device's orientation. In one embodiment, the user performs the task by performing one or more of pushing a button on the electronic device, pushing buttons on the electronic device in a sequence, performing touchscreen gestures on the electronic device, and rotating the electronic device. In one embodiment, the electronic device is further configured to prompt the user to perform the at least one task. In one embodiment, the processor is further configured to prompt the user to perform the at least one task upon entering a defined location. In one embodiment, the data specifying the at least one task is published to at least one user via at least one of auditory, visual, and haptic-based means on the electronic device. In one embodiment, the user is prompted to perform the at least one task upon scanning an indicia using the electronic device. In one embodiment, the reward is issued to the user through a blockchain-based system.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 illustrates a system for directing users to a location in accordance with one embodiment;

FIG. 2 illustrates the processor of FIG. 1 in accordance with one embodiment;

FIG. 3 illustrates an interface for specifying consumer criterion in accordance with one embodiment;

FIG. 4 illustrates a user receiving a publication of a task in accordance with one embodiment;

FIG. 5 illustrates a user receiving a publication of a task in accordance with another embodiment;

FIG. 6 illustrates a user receiving a publication of a task in accordance with another embodiment;

FIG. 7 illustrates a user receiving details of a particular task in accordance with one embodiment;

FIG. 8 illustrates a user performing the task detailed in FIG. 7 in accordance with one embodiment;

FIG. 9 illustrates a user performing a task of watching a video in accordance with one embodiment;

FIG. 10 illustrates a user receiving a publication of a task in a virtual environment in accordance with one embodiment;

FIG. 11 illustrates a user at a virtual environment in accordance with one embodiment;

FIG. 12 illustrates a user performing a game in a virtual environment in accordance with one embodiment;

FIG. 13 illustrates a user receiving discount coupons in a virtual environment in accordance with one embodiment;

FIG. 14 illustrates a user receiving gift vouchers in a virtual environment in accordance with one embodiment;

FIG. 15 illustrates a user receiving bitcoins in a virtual environment in accordance with one embodiment;

FIG. 16 illustrates a user receiving monetary credit on a mobile device in accordance with one embodiment;

FIG. 17 illustrates a user receiving loyalty points on a mobile device in accordance with one embodiment;

FIG. 18 illustrates a blockchain-based system for issuing a reward to a user in accordance with one embodiment; and

FIG. 19 depicts a flowchart of a method of directing users to a location in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

As mentioned previously, fewer customers visit brick-and-mortar stores as online shopping has become increasingly easy and efficient. The customers that do visit these stores tend to be interested in viewing products (e.g., trying on clothes, viewing pictures on a television, etc.), not purchasing them. Once a customer has found a particular product, they may then purchase the product from an online retailer at a lower price.

Accordingly, features of the present invention provide methods and systems that use augmented reality, virtual reality, or some variation thereof to incentivize people to visit brick-and-mortar stores or other locations. The methods and systems described herein may further incentivize a consumer to perform a task or make a purchase at said location by rewarding the consumer with one or more of coupons, cryptocurrency, vouchers, promotions, monetary credit, or the like.

Specifically, customers (users) may be prompted through a physical or digital advertisement to physically or virtually visit a location within a set timeframe. An augmented, virtual, or mixed reality-based action may then be required from the consumer once the consumer is at the location. Accordingly, features of the present invention help physical outlets remain relevant and competitive in the context of an increasingly digital society.

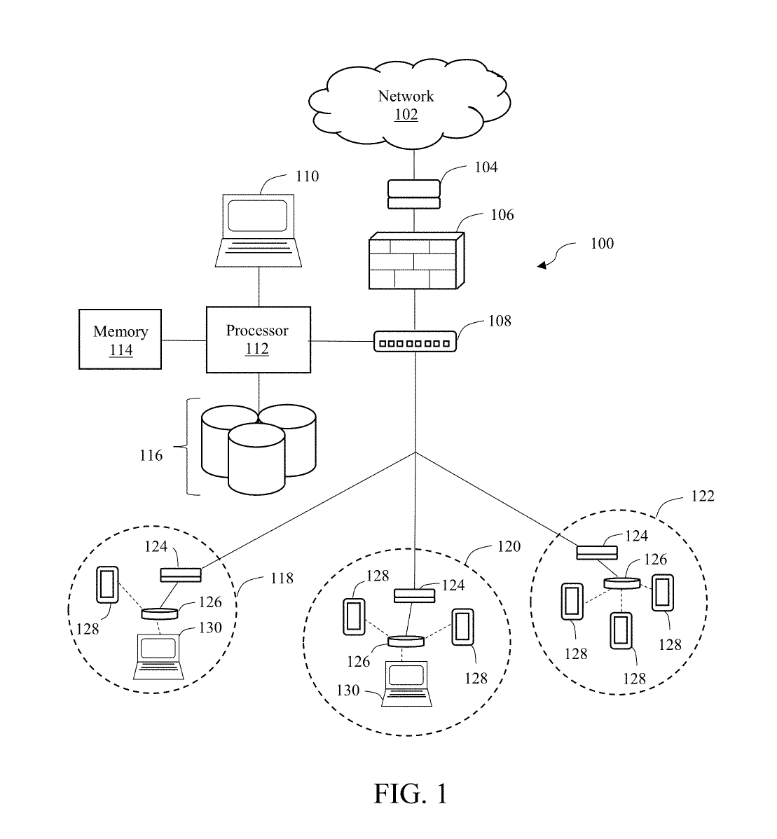

FIG. 1 illustrates a system 100 for directing users to a location in accordance with one embodiment. The system 100 may be implemented on or otherwise in connection with a network 102 with one or more routers 104 that enable communication among components of the system 100. The system 100 may further include a firewall 106 and an Ethernet hub and/or a network switch 108 for connecting various components of the system 100.

The system 100 may further include an interface 110 accessible by an operator such as a retailer administrator who wishes to create an location-associated task. The interface 110 may include or otherwise be in communication with a processor 112 that executes instructions stored on memory 114 and in further communication with one or more databases 116.

Data regarding advertising campaigns and tasks may be communicated to various devices located external from the interface 106 that are part of local area networks (LANs) 118, 120, and 122. The LANs may each include a modem 124, a router 126, and electronic user devices such as smartphones 128 and laptops 130. The system 100 illustrated in FIG. 1 is merely exemplary, and other types of components in addition to or in lieu of those shown in FIG. 1 may be included. For example, the system 100 may include additional servers, wireless routers, access points, etc.

The network 102 may link the various devices with various types of network connections. The network 102 may be comprised of, or may interface to, any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1, or E3 line, a Digital Data Service (DDS) connection, a Digital Subscriber Line (DSL) connection, an Ethernet connection, an Integrated Services Digital Network (ISDN) line, a dial-up port such as a V.90, a V.34, or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

The network 102 may also comprise, include, or interface to any one or more of a Wireless Application Protocol (WAP) link, a Wi-Fi link, a microwave link, a General Packet Radio Service (GPRS) link, a Global System for Mobile Communication G(SM) link, a Code Division Multiple Access (CDMA) link, or a Time Division Multiple access (TDMA) link such as a cellular phone channel, a Global Positioning System (GS) link, a cellular digital packet data (CDPD) link, a Research in Motion, Limited (RIM) duplex paging type device, a Bluetooth radio link, or an IEEE 802.11-based link.

The interface 110 may be accessible by an operator such as a company executive or other authorized personnel to specify details of an location-associated task. The interface 110 may enable the operator to input the underlying terms of the campaign, such as an incentive (e.g., a discount on a product, a voucher, monetary credit, etc.), the task that users must perform in order to receive the incentive, which user(s) receive the task.

The processor 112 may be any hardware device capable of receiving input regarding tasks, rewards associated with said tasks, criterion for specific users, and capable of publishing data regarding the tasks to users. The processor 112 may be a microprocessor, a field programmable gate array (FPGA), an application-specific integrated circuit (ASIC), or other similar devices. In some embodiments, such as those relying on one or more ASICs, the functionality described as being provided in part via software may instead be configured into the design of the ASICs and, as such, the associated software may be omitted. The processor 112 may be configured as part of the user interface 110 (e.g., a laptop) or may be located at some remote location.

The memory 114 may be L1, L2, L3 cache or RAM memory configurations. The memory 114 may include non-volatile memory such as flash memory, EPROM, EEPROM, ROM, and PROM, or volatile memory such as static or dynamic RAM, as discussed above. The exact configuration/type of memory 114 may of course vary as long as instructions for receiving data regarding tasks and rewards and for publishing data regarding tasks can be executed by the processor 112.

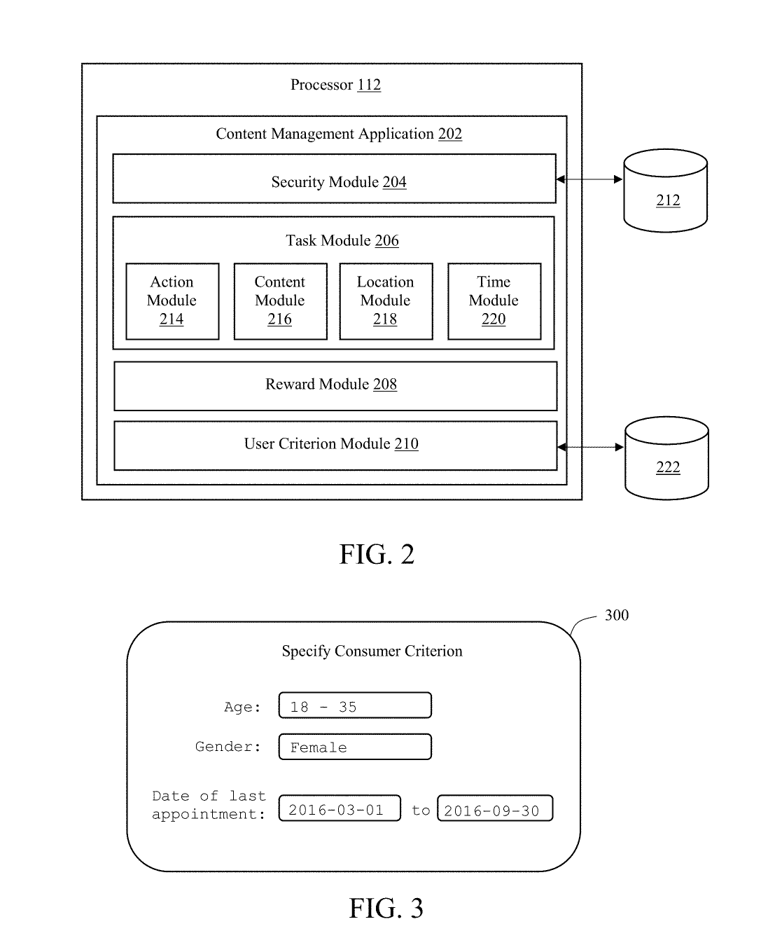

FIG. 2 illustrates the configured processor 112 of FIG. 1 in more detail. As shown in FIG. 2, the processor 112 may include a content management application 202 having a security module 204, a task module 206, a reward module 208, and a user criterion module 210.

The content management application 202 may be executed by the processor 112 to enable an operator to initiate a campaign of location-associated tasks. In operation, a publisher (e.g., an authorized operator) may log in to the content management application 202 via the security module 204. For example, the publisher may have an account with the system 100 that permits them to create and execute location-associated task campaigns.

The publisher may use the interface 110 input an account name and any other required credentials, which may then be compared to credentials stored in a security database 212. Once the publisher inputs acceptable credentials, the processor 112 may launch the content management application 202.

The task module 206 may allow the publisher to define one or more tasks associated with the campaign. The task module 206 may include an action module 214, a content module 216, a location module 218, and a time module 220.

The action module 214 may allow the publisher to input an action required to receive a reward. For example, the action module 214 may instruct the interface 110 to present a list of actions that a user must perform in order to receive the reward. This could be any one of traveling to a location (virtual and/or physical), taking picture(s) of an item, taking a picture of oneself at a location, taking video(s) of an item, playing a virtual reality game, scanning a barcode label (e.g., a 2D barcode, a QR code, etc.), or the like.

The above list is merely exemplary and it is contemplated that the publisher may assign other types of actions for the user to perform in order for the user to receive the reward. These may include real-world actions, virtual-based actions, augmented reality-based actions, or some combination thereof.

The content module 216 may allow the publisher to specify the content associated with the task. If the user is tasked to take a picture of an item, the content module 216 may allow the publisher to specify the particular item. If the user is tasked to play a virtual reality-based game, the content module 216 may allow the publisher to specify the type of game, the rules of the game, requirements of the game, etc.

The content module 216 may also allow the publisher to specify how content related to the task is displayed. For example, augmented reality content, virtual reality content, or some combination thereof can be digitally overlaid onto the physical or virtual world in the form of 2D images, 3D images, videos, or objects.

The location module 218 may allow the publisher to specify a location where the user is to perform the action. This may be a location in the physical world (such as a brick-and-mortar store, a restaurant, a park, a sporting venue, etc.), a location in a virtual world, or some combination thereof.

The time module 220 may allow the publisher to specify the time and/or dates for which the task and the reward is valid. For example, the publisher may specify a specific date or dates that the task is active (i.e., the dates the user may perform the task and receive the reward). The publisher may specify the date by inputting a specific day of the week, such as every Friday in the month of March. Or, the publisher may specify a range of dates consisting of consecutive days of a month.

The time module 220 may also allow the publisher to specify a certain time or window of time for which the task is valid. For example, the publisher may specify that a particular task is valid from 1:00 PM to 6:00 PM (EST) on Friday, Jun. 9, 2017. If the user performs the task within this window, they will receive the reward. If the user performs the task outside of this window, they will not receive the reward.

The reward module 208 may allow the publisher to associate one or more rewards with the task. For example, the reward module 208 may cause the interface 110 to present a list of reward types including, but not limited to, discount coupons, gift vouchers, monetary credit, cryptocurrencies, loyalty points, and virtual currencies. The publisher may also select or otherwise input the quantity/numerical value of the selected reward(s).

If the reward includes payment, such as monetary credit, the publisher may have a payment method set up to issue said payments. For example, the reward module 208 may be in operable communication with a financial institution (not shown) to facilitate financial transactions.

The user criterion module 210 may allow the publisher to define certain criterion for which users (e.g., customers) will receive data regarding the task. The publisher may wish to only provide data regarding the task and the reward to specific users. Accordingly, data regarding the task may be published to only select users that are most likely to be interested in performing the task.

For example, if the publisher is associated with a nail salon, and the reward is a voucher for use at the nail salon, the publisher may only wish to publish the task to women above a certain age. Additionally or alternatively, the criterion module 210 may allow a publisher to select users that subscribe to a mailing list of the publisher or to users that have visited the publisher in the past.

FIG. 3 illustrates an exemplary window 300 that may be presented by the interface 110 to an operator. This window 300 may enable the operator to input (e.g., via a keyboard or drop-down menus), certain criterion that specifies what types of users will receive the task. FIG. 3 specifies that female users aged 18-35 whose last appointment (e.g., at a nail salon) was between Mar. 1, 2016 and Sep. 30, 2016.

The criterion specified by the operator may be used to query one or more consumer criterion databases 222 for one or more users that satisfy the specified criterion. In return, the operator may receive a list of users that may be more likely to be interested in the promotion and therefore performing the task.

Referring back to FIG. 1, data may be published to users that are operating devices 128, 130 in communication with networks 118, 120, and 122. These networks may include modems 124 and routers 126 to communicate with electronic user devices 128 and 130. These devices 128 and 130 may include smartphones, smart watches, tablets, PCs, laptops, or the like. These devices may have application programming interfaces that allow the devices to execute instructions and interact with other components of the system 100.

A user may launch a client application on a device 128 or 130 that is integrated with the system 100 and may then be presented with a collection of all published tasks that are made available to said client application. Upon selecting a task, the user may be presented with instructions for earning a reward, as discussed below.

Once a publisher specifies a task and the associated reward(s), the processor 110 may then publish data regarding the task to the specified users. Data may be published in a variety of ways.

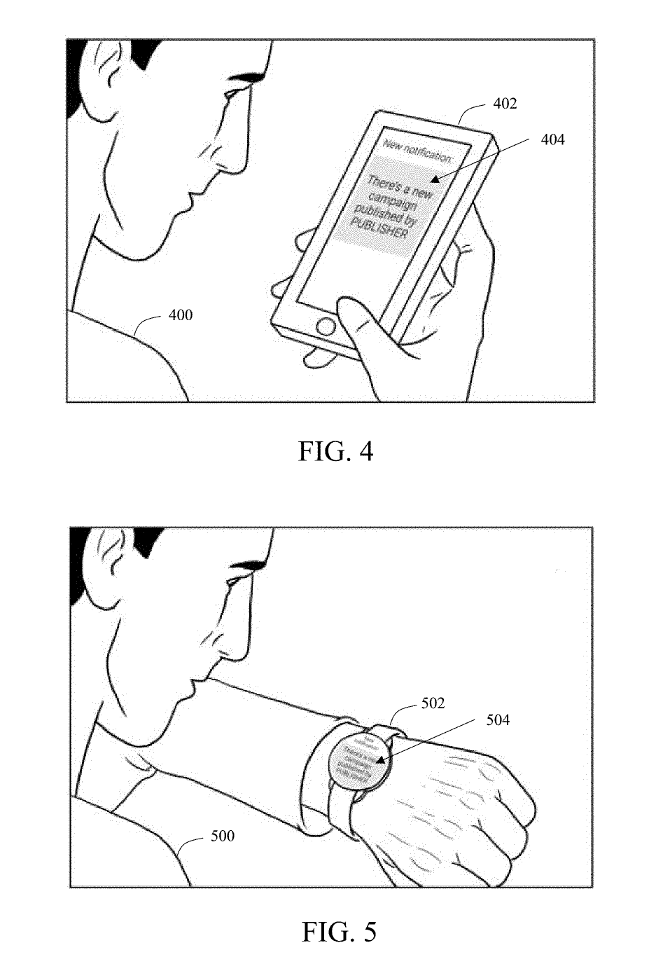

FIG. 4 illustrates a user 400 holding a mobile device 402 such as a smartphone. The mobile device 402 may similarly be configured as a tablet, laptop, or the like, or any suitable device executing appropriate application(s). As seen in FIG. 4, the mobile device 402 is presenting a message 404 to the user informing the user 400 that there is a new campaign published by “PUBLISHER.” The publisher in this case may be a clothing store, for example.

Depending on the settings of the mobile device 402 and/or the settings of the campaign, the user 400 may be prompted to check their mobile device 402 by way of a notification (similar to how a user would check their mobile device 402 after receiving a text message). The user may be notified through a visual notification, an audio notification, a haptic-based communication, or some combination thereof. Or, the user 400 may log into an application installed on their mobile device 400 or visit the publisher's website to see if there are any active campaigns.

FIG. 5 illustrates another embodiment in which a user 500 is wearing a smartwatch 502. As seen in FIG. 5, the smartwatch 502 is presenting a message 504 to the user 500 informing the user 500 that there is a new campaign published by “PUBLISHER.” Similarly, any type of smart wearable device executing any appropriate applications may also be used to inform a user of a campaign.

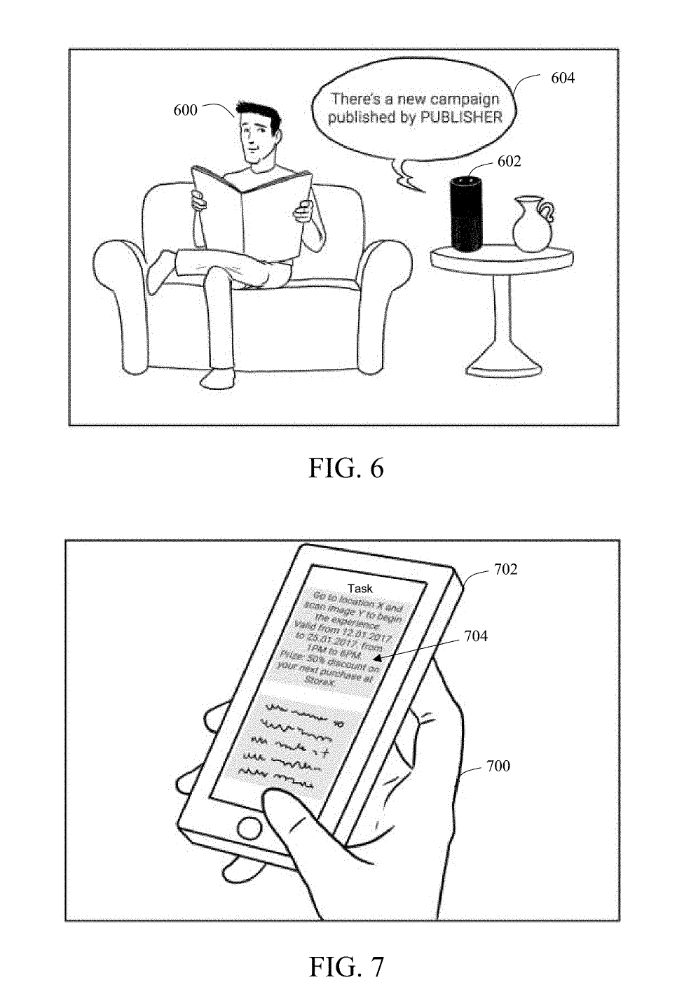

FIG. 6 illustrates another embodiment in which a user 600 is in the vicinity of a speaker device 602. As seen in FIG. 6, the speaker device 602 is presenting an audio message 604 informing the user 600 that there is a new campaign. Similarly, any type of Internet of Things device (e.g., televisions, refrigerators, dishwashers, laundry machines, etc.) may be used to inform a user of a campaign.

The user may then select a published campaign to learn of the associated task. For example, FIG. 7 illustrates a user 700 with a mobile device 702 that presents a message 704 informing the user of the task. In this particular embodiment, the user is instructed to go to a certain location (e.g., a retail store) to scan an image. Moreover, the user 700 is instructed to perform this task in a certain time window on a day falling within a specified date range. The message 704 further states the reward for performing the task which, in this case, is a 50% discount on the user's next purchase at a certain store.

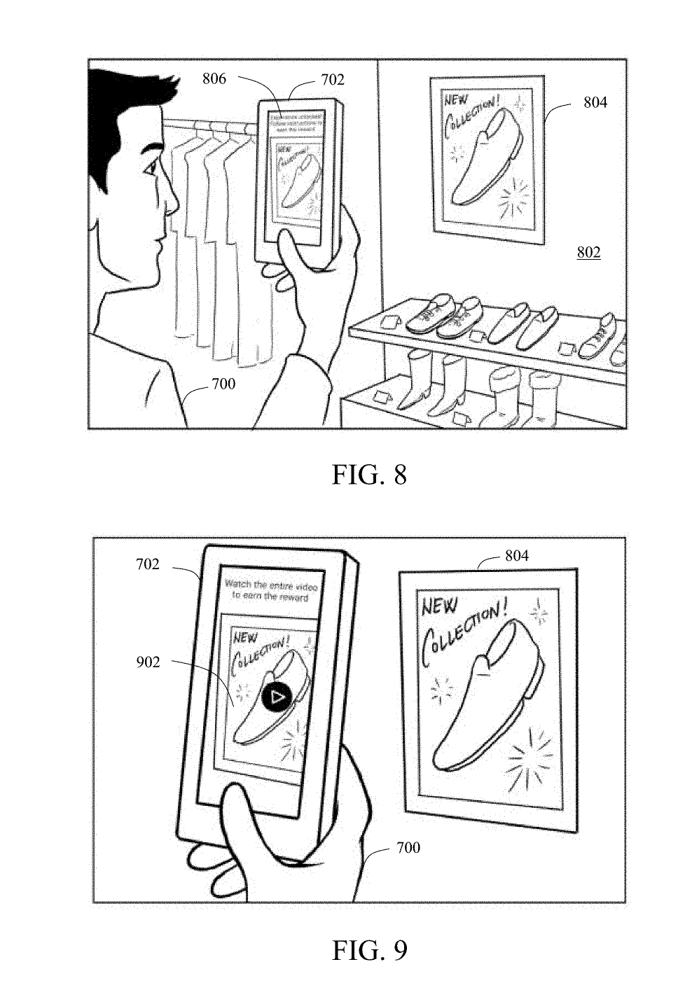

FIG. 8 illustrates the user 700 of FIG. 7 performing the task detailed in FIG. 7. Specifically, the user 700 has traveled to a retail store 802, and has found a printed advertisement 804 (which may correspond to “Image Y” referred to in the message 704 of FIG. 7).

As instructed by the message 704, the user 700 is aiming his mobile device 702 to face the image 804 such that the image 804 is presented in the screen of the mobile device 702. The user 700 may activate a scanning or image gathering application on their mobile device 702 to scan the image 804. In various embodiments, the user 700 may be instructed to gather an image of a sign, image(s) of a sign from different angles, a video of the sign, etc. The user 700 may then upload the image to the retailer's website, for example, or otherwise communicate the image to the publisher using, e.g., a social media service.

The scanning of an image as in FIG. 8 may be all that is required to receive the reward. Or, in some embodiments, scanning the image may simply be one task in a set of required tasks. FIG. 9, for example, illustrates the mobile device 702 of FIGS. 7 and 8 presenting a video 902 to the user 702. In this embodiment in particular, after the user 700 gathers the image of the sign 804, they may be prompted to watch a short video advertisement relating to the product advertised on the sign 804. Once the video concludes, the user 700 may be prompted with instructions regarding how to receive the reward.

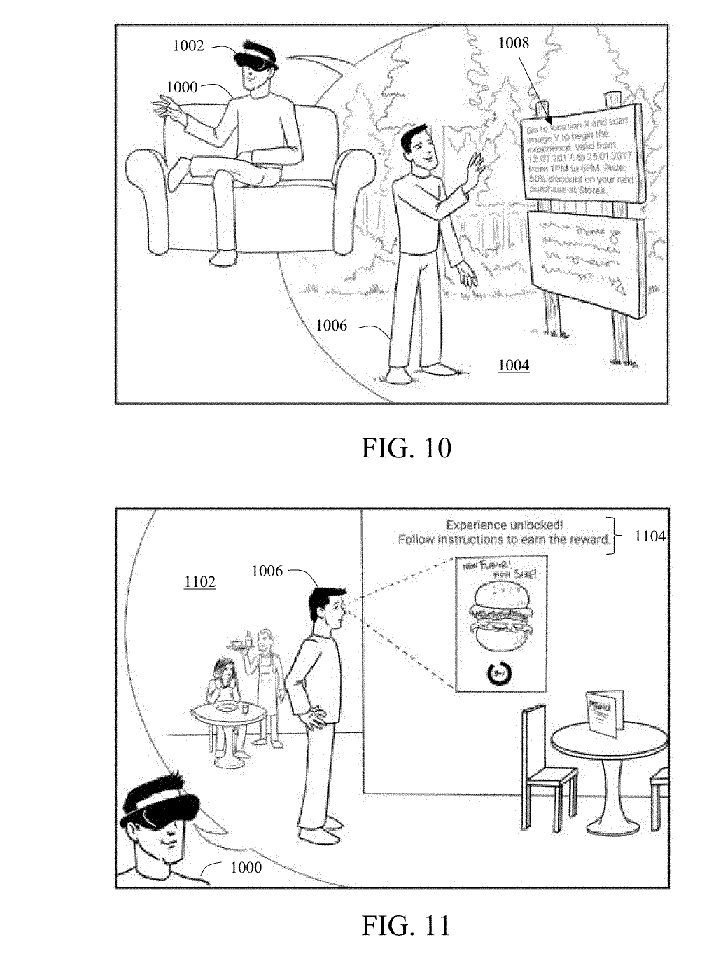

FIG. 10 illustrates another embodiment, in which a task is published to a user 1000 that is using a virtual reality headset 1002. In this embodiment, the virtual reality headset 1002 may present a virtual world 1004 to the user 1000, who is also represented in the virtual world 1004 as virtual user 1006.

To inform the user 1000 of a campaign (and the task), the virtual world 1004 may present to the virtual user 1006 a message 1008 at a certain location or time in the virtual world 1004. As seen in FIG. 10, the message 1008 may instruct the user 1006 to go to a virtual location. The message 1008 may further include information regarding the times and dates for which the task is valid, as well as the reward for performing the task.

FIG. 11 illustrates the virtual user 1006 of FIG. 10 in the virtual world, which in this embodiment is a virtual restaurant 1102. Based on the message 1008 in FIG. 10, the task may be to visit this virtual restaurant 1102 without having to perform any further actions once at the virtual restaurant 1002.

The user may move in the virtual world by any method available in the art. For example, the user may also use a handheld controller to control movements through the virtual world. Or, in some embodiments, the virtual reality headset 1002 may be configured with motion sensors that translate movements of the user 1000 to movements in the virtual world 1004. Once the virtual user 1006 walks into the virtual restaurant 1002, a virtual message 1104 may appear informing the user 1000 they have performed the required task and how to receive the reward.

In other embodiments, traveling to the virtual restaurant 1102 may be only one task of a set of tasks. Once at a specific virtual location, the user 1000 may be prompted to perform another step such as playing a game.

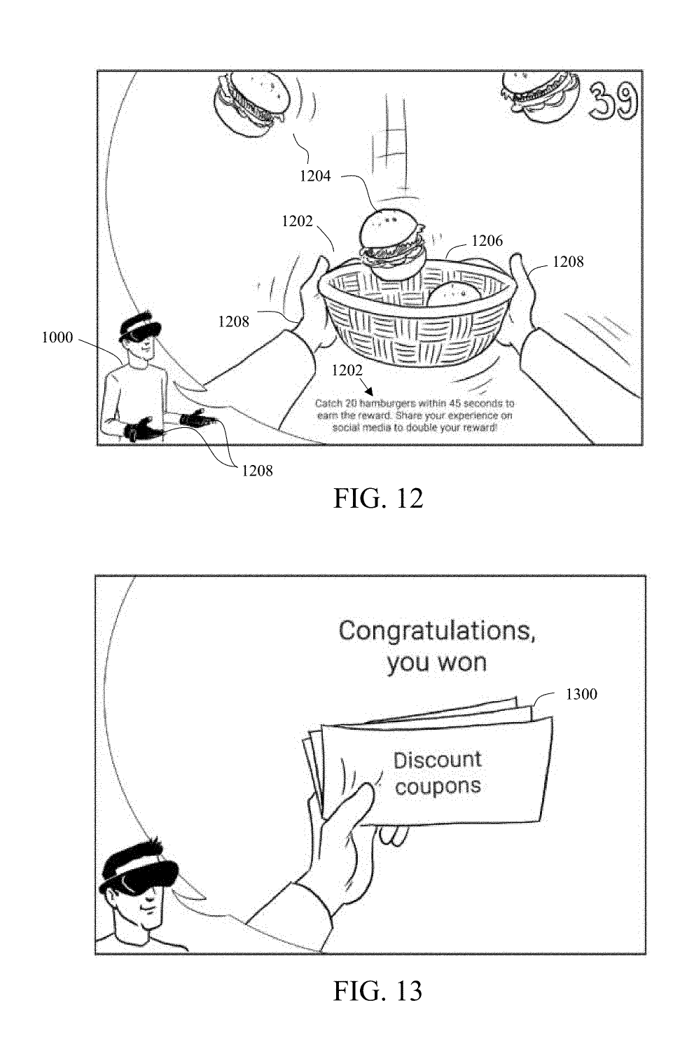

FIG. 12 illustrates the user 1000 playing a virtual reality game. In this particular game, the user 1000 may be presented with a message 1202 instructing him to catch a certain number of hamburgers 1204 with a basket 1206 within a time limit. The user 1000 may be wearing specially calibrated gloves 1208 with motion sensors such that as the user 1000 moves his hands (in the physical world), the user's virtual hands 1208 move the basket 1206 to catch burgers 1204.

Once the user performs the required task(s), the publisher may then issue one or more rewards to the user. As mentioned previously, the publisher may issue a variety of different types of rewards. For example, FIG. 13 illustrates a user receiving discount coupons 1300 in a virtual reality environment. The discount coupons 1300 may be credited to a user's account that is associated with the publisher, for example.

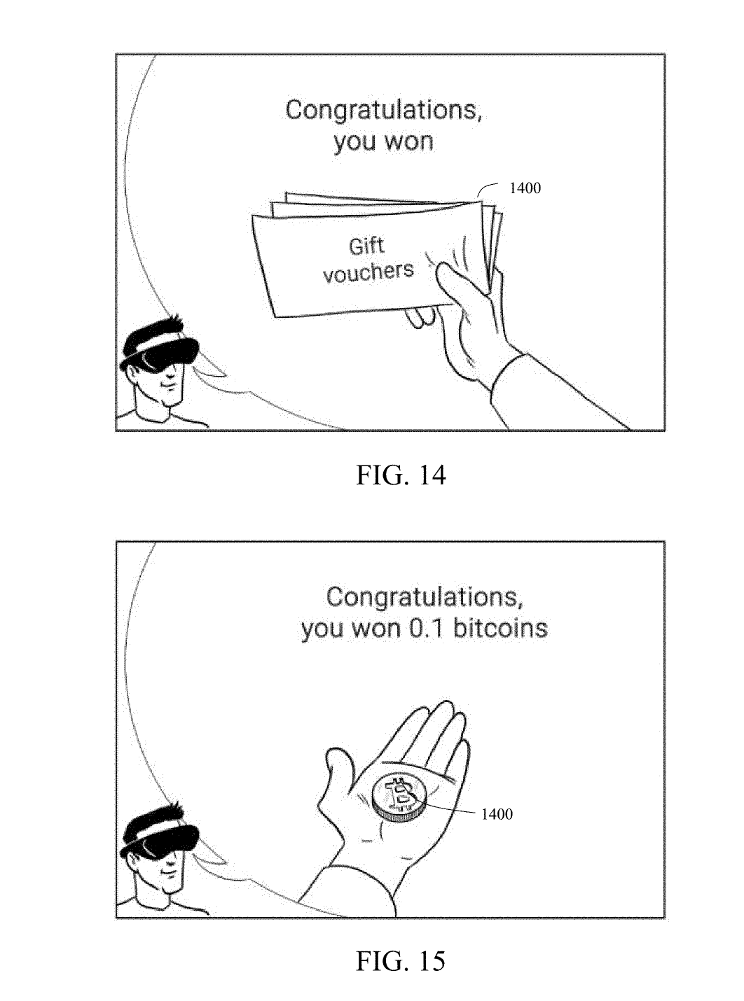

As another example, FIG. 14 illustrates a user receiving gift vouchers 1400 in a virtual reality environment. The gift vouchers 1400 may be applied towards purchases from the publisher.

As yet another example, FIG. 15 illustrates a user receiving cryptocurrency such as bitocoins. The user may also be presented with a message indicating the amount of cryptocurrency rewarded.

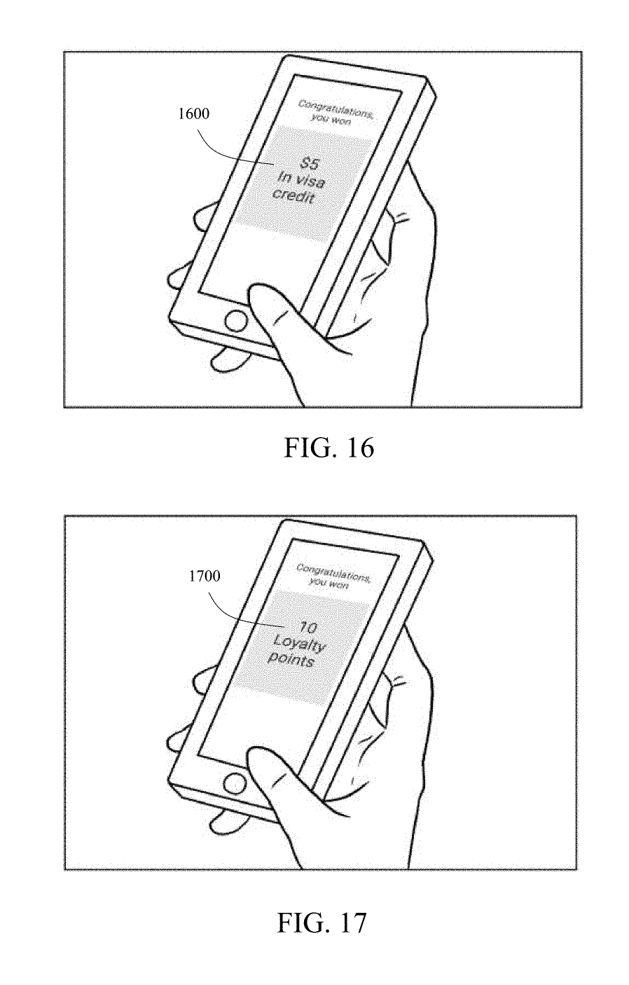

As yet another example, FIG. 16 illustrates a user receiving a message 1600 indicating they've earned five dollars in Visa® credit. This credit may be applied towards a purchase from the publisher or from any other participating institutions.

As yet another example, FIG. 17 illustrates a user receiving a message 1700 indicating they've earned 10 loyalty points. These loyalty points may be applied with the particular publisher of the task.

To issue the one or more rewards (particularly cryptocurrency), features of various embodiments of the invention may implement a blockchain-based system. Blockchain systems comprise a transaction ledger that updates in real time and provides a secure way to execute financial transactions.

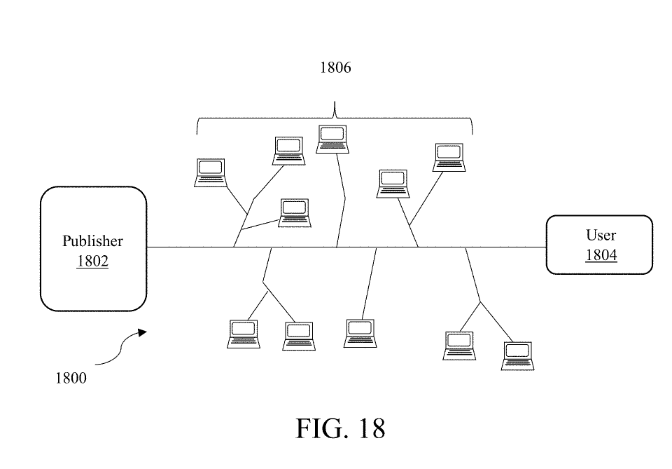

FIG. 18 illustrates an exemplary blockchain-based system 1800 that may be used to issue rewards to users in accordance with one embodiment. As seen in FIG. 18, the blockchain system 1800 includes a publisher in communication with a user 1804 over a network of devices 1806. When the publisher 1802 issues a reward to a user 1804, the transaction is broadcasted to the network 1806 for network devices to approve the transaction.

Once the network 1806 approves the transaction, the reward may be issued to the user 1804. Additionally, a record of the transaction will be stored as a block or component of a public ledger.

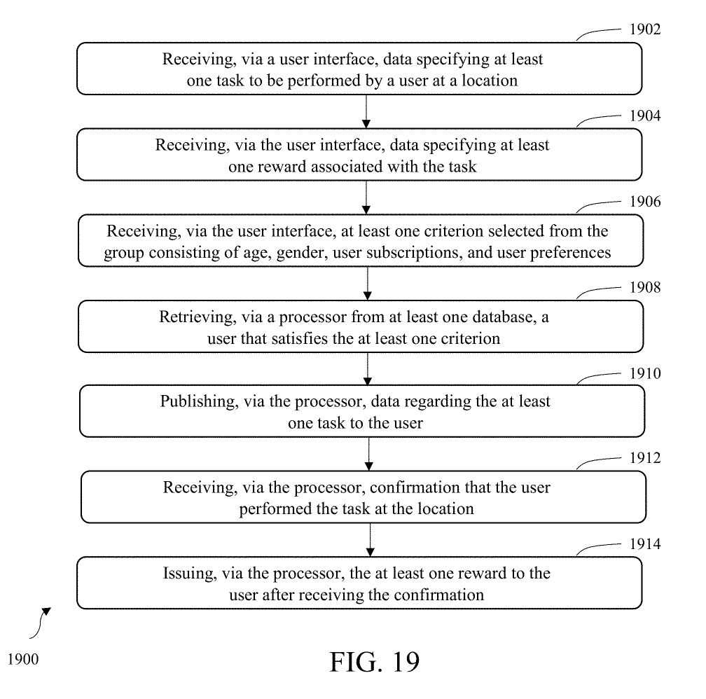

FIG. 19 depicts a flowchart of a method 1900 of directing users to a location in accordance with one embodiment. Step 1902 involves receiving, via a user interface, data specifying at least one task to be performed by a user at a location. This interface may be similar to the interface 110 of FIG. 1, for example. The task may involve user actions that are performed in the real world, in virtual reality, in augmented reality, or in some combination thereof. Similarly, the location may be a location in the real world, in virtual reality, or some combination thereof.

Step 1904 involves receiving, via the user interface, data specifying at least one reward associated with the task. The reward may incentivize users to go to a certain location, such as a virtual reality store or a brick-and-mortar store. The reward may include one or more of coupons, cryptocurrency, vouchers, promotions, monetary credit, or the like.

Step 1906 involves receiving, via the user interface, at least one criterion selected from the group consisting of age, gender, user subscriptions, and user preferences. Accordingly, a publisher may specify certain criterion for target users for the task.

Step 1908 involves retrieving, via a processor, from at least one database, a user that satisfies the at least one criterion. These databases may include the databases of FIG. 1 or 2, for example.

Step 1910 involves publishing, via the processor, data regarding the at least one task to the user. Accordingly, a publisher may target specific users for a particular campaign based on users that will be more interested in the campaign. Data regarding the task and reward may be published to the user by a user's electronic device such as a mobile device.

Step 1912 involves receiving, via the processor, confirmation that the user performed the task at the location. Once the user performs the task, the processor may issue the at least one reward to the user in step 1914.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method of directing users to at least one location, the method comprising:
receiving, via a user interface, data specifying at least one task to be performed by a user at a location;
receiving, via the user interface, data specifying at least one reward associated with the task;
receiving, via the user interface, at least one criterion selected from the group consisting of age, gender, user subscriptions, and user preferences;
retrieving, via a processor from at least one database, a user that satisfies the at least one criterion;
publishing, via the processor, data regarding the at least one task to the user;
receiving, via the processor, confirmation that the user performed the task at the location; and
issuing, via the processor, the at least one reward to the user after receiving the confirmation.

2. The method of claim 1, wherein the at least one reward includes one or more of a discount coupon, a gift voucher, monetary credit, digital currency, and cryptocurrency.

3. The method of claim 1, wherein the reward is issued to the user through a blockchain-based system.

4. The method of claim 1, further comprising receiving, via the user interface, data specifying a time period for the performance of the at least one task by the user, and the confirmation indicates that the task was performed within the time period.

5. The method of claim 1, wherein the task is published to one or more users via one or more electronic devices that are configured to change their displays as the user changes the electronic device's orientation.

6. The method of claim 5, wherein the user performs the task by performing one or more of pushing a button on the electronic device, pushing buttons on the electronic device in a sequence, performing touchscreen gestures on the electronic device, and rotating the electronic device.

7. The method of claim 5, further comprising prompting, using the electronic device, the user to perform the at least one task.

8. The method of claim 7, wherein the user is prompted to perform the at least one task upon entering a defined location.

9. The method of claim 5, wherein publishing data specifying the at least one task includes publishing data via at least one of auditory, visual, and haptic-based means on the electronic device.

10. The method of claim 5, wherein the user is prompted to perform the at least one task upon scanning an indicia using the electronic device.

11. A system for directing users to at least one location, the system comprising:
a user interface configured to:
receive data specifying at least one task to be performed by a user at a location,
receive data specifying at least one reward associated with the task, and
receive at least one criterion selected from the group consisting of user age, user sex, user subscriptions, and user preferences;
a memory; and
a processor, the memory storing instructions configuring the processor to:
retrieve, from at least one database, a user that satisfies the at least one criterion;
publish data regarding the at least one incentive task to the user;
receive confirmation that the user performed the task at the location; and
issue the at least one reward to the user after receiving the confirmation.

12. The system of claim 11, wherein the at least one reward includes one or more of a discount coupon, a gift voucher, monetary credit, digital currency, and cryptocurrency.

13. The system of claim 11, wherein the user interface is further configured to receive data specifying a time period for the performance of the at least one task by the user, and the confirmation indicates that the task was performed within the time period.

14. The system of claim 11, wherein the task is published to one or more users via one or more electronic devices that are configured to change their displays as the user changes the electronic device's orientation.

15. The system of claim 14, wherein the user performs the task by performing one or more of pushing a button on the electronic device, pushing buttons on the electronic device in a sequence, performing touchscreen gestures on the electronic device, and rotating the electronic device.

16. The system of claim 14, wherein the electronic device is further configured to prompt the user to perform the at least one task.

17. The system of claim 16, wherein the processor is further configured to prompt the user to perform the at least one task upon entering a defined location.

18. The system 14, wherein the data specifying the at least one task is published to at least one user via at least one of auditory, visual, and haptic-based means on the electronic device.

19. The system of claim 14, wherein the user is prompted to perform the at least one task upon scanning an indicia using the electronic device.

20. The system of claim 11, wherein the reward is issued to the user through a blockchain-based system.
